(19) United States
(12) Patent Application Publication
(10) Pub. No.: US 2013/0297300 A1
(43) Pub. Date: Nov. 7, 2013

(54) Automatic determination of stability and validity of Speech Transmission Index measurements

(71) Applicant: Sander Jeroen van Wijngaarden, Den Haag (NL)

(72) Inventor: Sander Jeroen van Wijngaarden, Den Haag (NL)

(21) Appl. No.: 13/463,834

(22) Filed: May 4, 2012

(51) Int. Cl. G10L 19/00

(52) U.S. Cl. CPC G10L 19/00
USPC 704/220

(57) ABSTRACT

The Speech Transmission Index (STI) uses the modulation transfer function to characterize speech communication channels with a single index. This index accurately predicts speech intelligibility. In order to measure the STI, a device or software is needed that utilizes an artificial test signal to estimate the modulation transfer function, and to derive the STI from that function. In practice, many STI measurements are found to be invalid and inaccurate, for two reasons: (1) the measurements are carried out in test conditions for which by design the STI is not intended; (2) equipment is used that does not meet specifications and requirements. A procedure is described to automatically verify if conditions for obtaining valid STI results are met. If possible, corrections are applied to compensate for incorrect settings and poorly adjusted measuring equipment. If automatic correction of the problem is not possible, then a warning is generated.

### BACKGROUND

The Speech Transmission Index (STI) is a widely used measure to predict speech intelligibility, based on physical measurements. The STI method uses an artificial test channel, which is presented to the input of a speech transmission channel. An STI analyzer at the output of the channel determines the actual STI, which is an index between 0 and 1. The speech transmission channel can be anything from a radio communication channel to the path between a talker and a listener inside a cathedral.

There are many different hardware devices and software tools that will measure the STI. Mostly, these are direct implementations of IEC-60268-16, the international standard which defines and standardizes the method. Although the standardized STI method was rigorously validated, STI measuring equipment are often found to produced results that are disappointing in terms of accuracy and reproducibility. In some cases, results are even found that are obviously faulty and invalid. This is due to two different causes: (1) the measurements were carried out in test conditions for which by design the STI is not intended and validated; (2) equipment is used that does not meet proper technical specifications and requirements.

The first category basically consists of ‘human error;’ users have failed to read the manual of their equipment, and choose to use their STI measuring device for a purpose that it was not designed for. For example, someone might use an STI measuring device to obtain intelligibility predictions in impulsive or strongly fluctuating background noise. The IEC standard states that the method cannot be used in such a case; the manual of any measuring device should also include such a warning. Still, this problem does occur quite often, resulting in STI values that may be much lower or higher than expected for the given situation.

Problems in the second category are not directly caused by human errors, but by technical issues with test signal playback equipment. The most common problem is that playback equipment (such as CD players) are used to generate the test signal, which function at a sampling frequency that is slightly too low or high. The resulting frequency shifts of the test signal are inaudible to the human ear, and do not have an impact on speech intelligibility, but do have a drastic impact on the measured STI value.

The reliability of an STI measuring device in practice can be greatly enhanced if these sources of measuring errors are correctly identified by the measuring device itself. The measuring device can then either warn the operator, or in some cases apply corrections to the raw measurement data in order to eliminate the problem.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The disclosed invention is a subsystem to be added to Speech Transmission Index measuring devices that determines if the measurement is stable and valid. Intermediate measurement data, the Modulation Transfer Function matrix and the octave band sound pressure levels, are inspected for signs of instability and apparent lack of validity. A heuristic reliability metric is defined, as well as a threshold for this metric above which the measurement is considered to be unreliable. The subsystem looks for signs of instability and inconsistency in intermediate measurement data, and modifies the reliability matrix accordingly. This is done by comparing intermediate data to preset thresholds, and checking the overall data pattern for inconsistency. A warning is presented to the user if the heuristic reliability metric exceeds a preset threshold.

A separate calibration subsystem is also present, that is not included in the normal STI measuring process, but can be activated as a separate mode. This subsystem adjusts the system parameters, in particular the sampling frequency, to correct for mismatches between STI analyzed and test signal playback equipment.

These and other features will be addressed in greater detail below.

### BRIEF DESCRIPTION OF THE DRAWING

FIG. 1 is a block diagram of the measuring error detection and correction system. The gray blocks are existing parts of the normal STI measuring system, the other blocks are part of the disclosed invention.

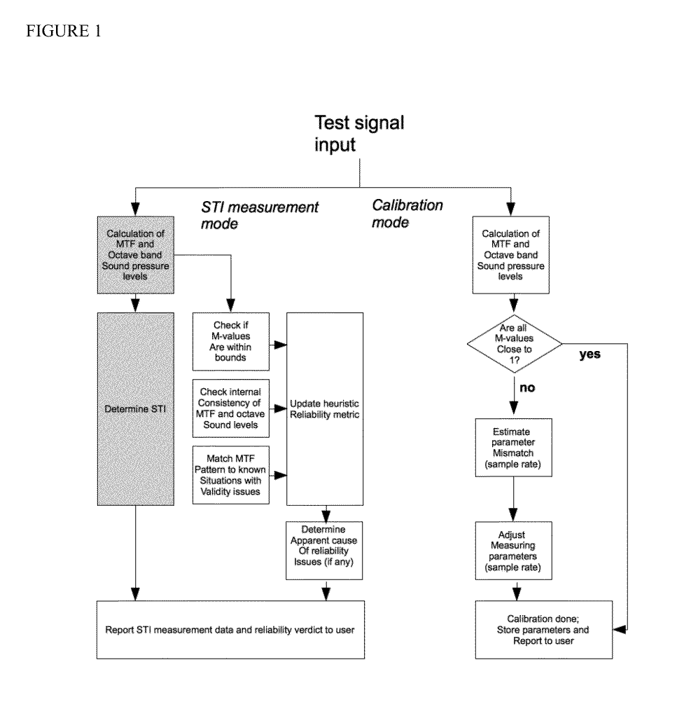

### DETAILED DESCRIPTION

The invention disclosed is a system, to be implemented in hardware and/or software, that continually monitors the accuracy and validity of an STI measurement, and if necessary takes action to warn the user, or to autonomously correct measuring problems. This system is included as a subsystem in devices or software that perform STI measurements.

The Speech Transmission Index is derived from a characteristic of the transmission channel that is called the Modulation Transfer Function (MTF). As a first stage to any STI measurement, the MTF is estimated from an analysis of the recorded test signal. In the STI model, the MTF is a matrix of so-called m-values, for different modulation frequencies between 0.63 and 12.5 Hz, and octave bands between 125 Hz and 8 kHz. How densely or sparsely this matrix is filled may differ, depending on the type of test signal and the version of the STI-model that is used. Also, sound levels are measured in octave bands between 125 Hz and 8 kHz.

The octave band levels and MTF matrix are considered ‘intermediate results’, and are the input for the calculation of the STI index itself. The exact algorithms are standardized in IEC-60268-16.

The essence of the invention is to use these same intermediate results (MTF and octave band sound pressure levels) in order to determine the validity and stability of the measurement. This is done in the following steps:

1. A heuristic metric is defined to indicate the reliability of a measurement, in the form of a system variable. For every deviation from the expected patterns (as outlined in the following steps), the value of this variable is increased.

2. Determine if individual elements of the MTF-matrix (so-called m-values) are within reasonable bounds; i.e., they should not exceed 1 by more than a reasonable error margin.

3. Determine if the m-values form a pattern that is internally consistent, and also consistent with the octave band sound pressure levels. In particular, m-values for which the modulation frequencies are close to each other are expected to show a relatively small difference.

4. If differences between m-values occur that are greater than expected based on pure statistics, the MTF-matrix is investigated to find out if these is a systematic cause, such as consistent differences between octave bands. If no such pattern is found, then this indicates that the reliability of the measurement is reduced.

5. If the heuristic reliability matrix exceeds a preset threshold, the overall pattern of the MTF-matrix is further investigated to determine the potential cause of the apparent fact that the measurement is invalid or incorrect. Different causes (i.e., different types of human errors in applying the method) translate to distinct patterns, to which the intermediate measurement data can be matched.

The procedure described above is followed as soon as the MTF matrix is calculated; this is when the measurement itself (which takes about 25 seconds) is finished, and before the STI is calculated an displayed. If the calculated heuristic reliability metric exceeds a preset threshold, then a warning is generated to the user. If pattern matching reveals a probable cause for the fact that the measurement is inaccurate or invalid, this may be reported to the user as well.

The above procedure becomes a part of the STI measuring system itself, as a newly added subsystem. Additionally, a subsystem is added the does not become part of the STI measuring system itself, but rather acts as a separate measurement. This takes the form of a function that the user can call to actively test the validity of the system itself, and to adjust the measuring system to the technical system parameters of the measuring system. We call this the ‘calibration subsystem.’

The calibration subsystem requires a clean, undistorted test signal to be presented to the STI analyzer, so that (for a properly functioning setup) the STI should at least exceed 0.95. The calibration subsystem then carries out a standard STI and MTF measurement. If m-values are found that are lower then expected, the subsystem tries to determine if the problem can be solved by adjusting parameters of the measuring system, in particular the sample rate. If the problem appears to be a mismatch in sampling rate between the test signal and the analyzer, then this mismatch is estimated and an adjustment is applied.

What is claimed is:

1. A subsystem of Speech Transmission Index measuring software or hardware, implemented as software, hardware, or a combination of software and hardware, that automatically evaluates the stability, reliability or validity of Speech Transmission Index measurements

2. A subsystem as described in claim 1, comprising software which automatically corrects Speech Transmission Index measurement results or intermediate measurement results from which the STI is calculated for apparent causes of measurement errors.

3. A subsystem as described in claim 1, comprising software which automatically provides warnings if apparent causes of measurement errors are detected, or if conditions are detected which render the STI measurement invalid.

4. A subsystem as described in claim 1, comprising software which detects errors in the sampling rate of the apparatus used to play back test signal.

5. A subsystem as described in claim 4, comprising software which corrects the sampling rate of the Speech Transmission Index analyzer in order to compensate for errors in the sampling rate of the test signal playback apparatus.

6. A subsystem as described in claim 1, comprising software that evaluates if elements of the modulation transfer function matrix fall within a predetermined range known to correspond to accurate and reliable measurements.

7. A subsystem as described in claim 1, comprising software that evaluates if the modulation transfer function matrix, or parts thereof, is consistent within patterns known to correspond to accurate and reliable measurements.

8. A subsystem as described in claim 1, comprising software that analyses the octave band spectrum levels and modulation transfer function in order to identify which sources of speech signal degradation are present in the transmission path.

9. A subsystem as described in claim 8, comprising software that determines if measured octave band spectrum levels and modulation transfer function are consistent with patterns known to correspond to accurate and valid measurements
